(19) United States
(12) Patent Application Publication
(10) Pub. No.: US 2006/0088814 A1
(43) Pub. Date: Apr. 27, 2006

(54) Enhanced cell preservative solution and methods for using same

(75) Inventors: Steven A. Hecht, Cambridge, MA (US); Wendy E. Swinehart, Leominster, MA (US)

Correspondence Address: CYTYC CORPORATION, 250 CAMPUS DRIVE, MARLBOROUGH, MA, 01752, US

(73) Assignee: CYTYC CORPORATION

(21) Appl. No.: 11/256,289

(22) Filed: Oct. 21, 2005

Related U.S. Application Data
(60) Provisional application No. 60/622,100, filed on Oct. 26, 2004.

(51) Int. Cl. A01N 1/02

(52) U.S. Cl. 435/2

(57) ABSTRACT

The present invention relates to an aqueous alcohol buffer solution for substantially ambient, in vitro preservation of mammalian cells for a selected duration.

### FIELD OF THE INVENTION

A unique cell preservative solution and methods for using that solution are disclosed. The formulation preserves cells in vitro in an ambient liquid suspension; minimizes protein precipitation; reduces cell clumping; selectively eliminates or reduces red blood cell; and retains nucleic acid and protein integrity for further analysis.

### BACKGROUND OF THE INVENTION

The present invention relates to a preservative solution for use in the processing of cell and tissue samples and more particularly relates to a novel combination of agents for the preservation of mammalian cell samples for use in preparing specimen slides for microscopic evaluation. It is known in the clinical and research arenas that preservation of cell samples for subsequent analysis is desirable. From a diagnostic standpoint, a specimen is most valuable when it is fresh. The more time that elapses between collection of a specimen and its transfer to a slide or other matrix, the less integrity is retained. Depriving cells of the physiologic conditions of its donor for long periods of time, i.e., minutes, allows autolysis to begin. Properly preserving cellular samples such as cells, cell aggregates and small tissue fragments derived from collections of human or animal tissue is a prerequisite to the accurate diagnosis of disease, especially cancer.

Cytology is a branch of biology dealing with the study of the formation, structure, morphology, and function of cells. As applied in a laboratory setting, cytologists, cytotechnologists, and other medical professionals make medical diagnoses of a patient's condition based on visual examination of a specimen of the patient's cells. A typical cytological technique is a “pap smear” test, in which cells are scraped from a woman's cervix and analyzed microscopically in order to detect the presence of abnormal cells, a precursor to the onset of cervical cancer. Cytological techniques are also used to detect abnormal cells and disease in other parts of the human body.

Cytological techniques are widely employed because collection of cell samples for analysis is generally less invasive than traditional surgical pathological procedures such as biopsies, whereby a tissue specimen is excised from the patient using specialized biopsy needles having spring loaded translatable stylets, fixed cannulae, and the like. Cell samples may be obtained from the patient by a variety of techniques including, for example, by scraping or swabbing an area, or by using a needle to aspirate body fluids from the chest cavity, bladder, spinal canal, or other appropriate area. In the processing of tissues for glass slides, the tissues are clinically removed from a patient and placed in a container that often contains a preservative and/or fixative and is then transported to the lab for further treatment or conditioning.

Until recently, chemical fixatives were primarily used for the conditioning of the cellular samples. The chemical reagents used as fixatives are those that preserve tissue components for an extended period of time without deterioration. Generally, alcohol solutions, with or without other additives such as polyethylene glycol and formaldehyde, ranging from 50% to 95% (v/v: methanol, ethanol, isopropanol) are known solutions for use in fixation. When alcohol solutions greater than 50% (v/v) are used for collecting and fixing fluids high in protein, however, a protein sediment forms which can subsequently precipitate. Protein sedimentation makes the fixed cytologic material difficult to transfer to glass slides for examination, regardless of whether the transfer is done by direct application to the glass slide, by cytofiltration through a small pore filter, or by cytocentrifugation onto glass slides coated with an adhesive such as chrome alum gelatin. Also, alcohol fixatives greater than about 50% (v/v) that are used for collecting and fixing cytologic specimens are not optimum fixatives because the processed cells become distorted in their appearance.

The presence of cross linking agents (such as glutaraldehyde, paraformaldehyde, formalin or formaldehyde) may have an adverse impact on the analytical tests that are performed on preserved tissue. Formaldehyde, which is a very reactive electrophilic species, fixes tissue by combining with proteins and nucleic acids therein (see e.g., Varshavsky et al., Cell. June 17; 53(6):937-47 (1988)). However, cross linkages inside the preserved tissue prevent the large probe molecules employed in analytical tests, particularly antibodies and oligo- or polynucleotides, from penetrating (see e.g., Ikeda, Journal of Histochemistry and Cytochemistry, Vol. 46, 397-404 (1998); see also Nongynecological Cytology Practice Guidelines prepared by the American Society of Cytopathology, Cytopathology Practice Committee, Mar. 2, 2004). Reduced access by these probe molecules translates into loss of assay sensitivity.

Hybridization can also be done on soluble extracts prepared from tissue or cells for a composition assay (e.g., in gels or blots). Fixative modifications can compromise either the extraction efficiency, or the reactivity of the analyte. For example, fixation may affect the extraction efficiency of nucleic acids or the efficiency of subsequent nucleic acid amplification.

There are commercially available alcohol-based cell fixatives (40-50% (v/v)) on the market. For example, PreservCyt®, (Cytyc Corporation, Marlborough, Mass.), is a methanol-based, buffered, solution designed to support cells during transport and microscope slide preparation with the ThinPrep® Processor.

As an alternative to alcohol-based fixatives, several types of saline or balanced salt, alcohol-free solutions are commercially available for preserving cell specimens in the interim between sampling and fixation and/or analysis. A few of these solutions includes Hanks' balanced salt solution, a minimal essential tissue culture medium (MEM), and normal saline. The high cost of some medium, such as Hanks' and MEM, prohibits its routine use. Moreover, alcohol-free solutions that are the most versatile cannot be stored for a long amount of time or transported over long distances due to problems with contamination by microorganisms and may not preserve cellular morphology over extended periods of time. See, Boon, M. E. and Lykles, C., “Imaginative Approach to Fine Needle Aspiration Cytology,” Lancet, 1031-1032 (1980).

Many types of clinical tissue and cell samples contain extraneous molecules. Specimens may contain blood, mucous, tissue fluids, and extraneous macromolecules. These components can precipitate in alcoholic fixatives and thus may interfere with subsequent slide preparation, staining and analysis. Cytologic material with a high red blood cell content dilutes the cell population of diagnostic interest by red blood cells. Methods have been used to decolorize the red blood cells in such cytologic specimens such as post-fixation of the cytologic specimen slide in Carnoy's solution comprising 60% ethanol, 30% chloroform and 10% glacial acetic acid (v/v). Such post-fixation of the cytologic specimen slide creates the additional problem of diluting the number of diagnostic cells on the cytologic specimen slide. Also, as mentioned previously, fixatives containing high amounts of alcohol have problems with protein precipitation and morphological distortion.

It is generally desirable that the cells on the slide have a proper spatial distribution, so that individual cells can be examined. A single layer of cells is typically preferred. Accordingly, preparing a specimen from a fluid sample containing many cells typically requires that the cells first be separated from each other by mechanical dispersion, fluidic shear, or other techniques so that a thin, monolayer of cells can be collected and deposited on the slide. In this manner, the cytotechnologists can more readily discern abnormal cells. The cells are also able to be counted to ensure that an adequate number of cells have been evaluated. Certain methods and apparatus for generating a thin monolayer of cells on a slide advantageous for visual examination are disclosed in U.S. Pat. No. 5,143,627 issued to Lapidus et al. and entitled “Method and Apparatus for Preparing Cells for Examination;” U.S. Pat. No. 5,240,606 issued to Lapidus et al. and entitled “Apparatus for Preparing Cells for Examination;” U.S. Pat. No. 5,269,918 issued to Lapidus et al. and entitled “Clinical Cartridge Apparatus;” and U.S. Pat. No. 5,282,978 issued to Polk, Jr. et al. and entitled “Specimen Processor Method and Apparatus,” all of which are assigned to the assignee of the present invention and all of the disclosures of which are incorporated herein by reference in their entirety.

Once a specimen is prepared, fixed, and stained, the specimen may be manually visually inspected by a cytotechnologists, typically under magnification, and with or without various sources of illumination. Alternatively or additionally, automated machine vision systems have been adapted to aid cytological inspection. For example, an automated vision system may perform a preliminary assessment of the entire slide on which the specimen is disposed to alert the cytotechnologists to potentially the most relevant areas of the slide for close inspection, or may be used to rescreen specimens already analyzed by the cytotechnologists.

### SUMMARY OF THE INVENTION

This invention generally relates to a solution and method for the preservation of cells and tissue. The solution is an alcohol buffer solution for in vitro preservation of mammalian cells at ambient temperatures following removal from a mammalian body, and prior to transferring to a slide, staining or other forms of molecular analysis.

In one aspect of the present invention, a method of preserving cells in a solution is provided, said method comprising the steps of collecting cells from a patient and suspending said cells in a cell preservative solution, said solution comprising about twenty to thirty percent alcohol, an anti-clumping agent in an amount sufficient to prevent the cells from clumping in said solution, and a buffering agent which maintains said solution, with the cells, at a pH of about seven, wherein said solution maintains the structural integrity of cells at ambient temperature in vitro while increasing the solubility of hemoglobin.

In another aspect of the invention, a method of preserving cells in a solution is provided, said method comprising the steps of collecting cells from a patient and suspending said cells in a cell preservative solution, said solution comprising alcohol in a concentration sufficient to preserve but not fix said cells, an anti-clumping agent in an amount sufficient to prevent the cells from clumping in said solution, and a buffering agent which maintains said solution, with the cells, at a pH of about seven, wherein said solution maintains the structural integrity of said cells at ambient temperature in vitro while increasing the solubility of hemoglobin.

In another aspect of the invention, a method of preserving cervical cells in a solution is provided, said method comprising the steps of collecting cervical cells from a patient and suspending said cervical cells in a cell preservative solution, said solution comprising alcohol in a concentration sufficient to preserve but not fix said cervical cells, an anti-clumping agent in an amount sufficient to prevent the cervical cells from clumping in said solution, and a buffering agent which maintains said solution, with the cervical cells, at a pH of about seven, wherein said solution maintains the structural integrity of said cervical cells at ambient temperature in vitro while increasing the solubility of hemoglobin.

In a yet another aspect of the invention, a method of preserving cells in a solution is provided, said method comprising the steps of collecting cells from a patient; and suspending said cells in a cell preservative solution, said solution comprising about 24% methanol or ethanol by volume, about 0.07% ProClin 300 antibacterial agent, about 3 mM EDTA, about 200 parts per million cholic acid, about 0.1% sodium chloride, about 5 mM potassium chloride, about 1 mM calcium acetate, and about 6 mM magnesium acetate at a final pH of 7.0, wherein said solution maintains the structural integrity of cells at ambient temperature in vitro while increasing the solubility of hemoglobin.

In a yet another aspect of the invention, a method of preserving cervical cells in a solution is provided, said method comprising the steps of collecting cervical cells from a patient; and suspending said cervical cells in a cell preservative solution, said solution comprising about 24% methanol or ethanol by volume, about 0.07% ProClin 300 antibacterial agent, about 3 mM EDTA, about 200 parts per million cholic acid, about 0.1% sodium chloride, about 5 mM potassium chloride, about 1 mM calcium acetate, and about 6 mM magnesium acetate at a final pH of 7.0, wherein said solution maintains the structural integrity of said cervical cells at ambient temperature in vitro while increasing the solubility of hemoglobin.

In still another aspect of the invention, a method of preserving cells to render them useful for subsequent immunological, genetic, or cytological analysis is provided, wherein the method comprises the steps of collecting cells from a patient suspending said cells in a cell preservative solution, said solution comprising about twenty to thirty percent alcohol an anti-clumping agent in an amount sufficient to prevent the cells from clumping in said solution and a buffering agent which maintains said solution, with the cells, at a pH of about seven, and removing a portion of said preserved cells for immunological, genetic, or cytological analysis.

In still another aspect of the invention, a method of preserving cervical cells to render them useful for subsequent immunological, genetic, or cytological analysis is provided, wherein the method comprises the steps of collecting cervical cells from a patient suspending said cervical cells in a cell preservative solution, said solution comprising about twenty to thirty percent alcohol an anti-clumping agent in an amount sufficient to prevent the cervical cells from clumping in said solution and a buffering agent which maintains said solution, with the cells, at a pH of about seven, and removing a portion of said preserved cervical cells for immunological, genetic, or cytological analysis.

In yet another aspect of the present invention, a method of preserving cells to render them useful for subsequent immunological, genetic, or cytological analysis is provided, wherein the method comprises the steps of collecting cells from a patient suspending said cells in a cell preservative solution, said solution comprising about 24% methanol or ethanol by volume about 0.07% ProClin 300 antibacterial agent about 3 mM EDTA about 200 parts per million cholic acid about 0.1% sodium chloride about 5 mM potassium chloride about 1 mM calcium acetate, and about 6 mM magnesium acetate at a final pH of 7.0., and removing a portion of said preserved cells for immunological, genetic, or cytological analysis.

In still another aspect of the present invention, a method for the preparation of a specimen slide is provided, the steps comprising collecting a cell sample from a patient suspending the cell sample in a suitable volume of preservative solution said preservative solution comprising about twenty to thirty percent alcohol an anti-clumping agent in an amount sufficient to prevent the cells from clumping in said solution; and a buffering agent which maintains said solution, with the cells, at a pH of about seven, and applying the preserved, suspended sample to a slide for analysis.

In yet another aspect of the present invention, a method for the preparation of a specimen slide is provided, the steps comprising collecting a cell sample from a patient suspending the cell sample in a suitable volume of preservative solution said preservative solution comprising about 24% methanol or ethanol by volume about 0.07% ProClin 300 antibacterial agent about 3 mM EDTA about 200 parts per million cholic acid about 0.1% sodium chloride about 5 mM potassium chloride about 1 mM calcium acetate, and about 6 mM magnesium acetate at a final pH of 7.0, and applying the preserved, suspended sample to a slide for analysis.

In still another aspect of the present invention, a method for the preparation of a specimen slide is provided, the steps comprising collecting a cell sample from a patient suspending the cell sample in a suitable volume of preservative solution said preservative solution comprising about twenty to thirty percent alcohol an anti-clumping agent in an amount sufficient to prevent the cells from clumping in said solution; and a buffering agent which maintains said solution, with the cells, at a pH of about seven; and applying the preserved, suspended sample to a slide, wherein said slide is subsequently used for immunological or genetic analysis.

In yet another aspect of the present invention, a method for the preparation of a specimen slide is provided, the steps comprising collecting a cell sample from a patient suspending the cell sample in a suitable volume of preservative solution said preservative solution comprising about 24% methanol or ethanol by volume about 0.07% ProClin 300 antibacterial agent about 3 mM EDTA about 200 parts per million cholic acid about 0.1% sodium chloride about 5 mM potassium chloride about 1 mM calcium acetate, and about 6 mM magnesium acetate at a final pH of 7.0; and applying the preserved, suspended sample to a slide, wherein said slide is subsequently used for immunological or genetic analysis.

In one embodiment of the present invention, a cell preservative solution is provided, wherein the preservative solution comprises about 24% methanol or ethanol, about 0.07% ProClin 300 antibacterial agent, about 3 mM EDTA, about 200 parts per million cholic acid, about 0.1% sodium chloride, about 5 mM potassium chloride, about 1 mM calcium acetate, and about 6 mM magnesium acetate at a final pH of 7.0.

In another embodiment of the present invention, a cell preservative solution is provided, wherein the preservative solution comprises about 24% methanol or ethanol, about 0.07% ProClin 300 antibacterial agent, about 3 mM EDTA, about 200 parts per million cholic acid, about 0.1% sodium chloride, about 5 mM potassium chloride, about 1 mM calcium acetate, and about 6 mM magnesium acetate at a final pH of 7.0, and said solution maintains the structural integrity of said cells at ambient temperature in vitro while increasing the solubility of hemoglobin.

In another embodiment of the present invention, a cervical cell preservative solution is provided, wherein the preservative solution comprises about 24% methanol or ethanol, about 0.07% ProClin 300 antibacterial agent, about 3 mM EDTA, about 200 parts per million cholic acid, about 0.1% sodium chloride, about 5 mM potassium chloride, about 1 mM calcium acetate, and about 6 mM magnesium acetate at a final pH of 7.0, and said solution maintains the structural integrity of said cervical cells at ambient temperature in vitro while increasing the solubility of hemoglobin.

In another embodiment of the present invention, a cell preservative solution is provided, wherein the preservative solution comprises about 24% methanol or ethanol, about 0.07% ProClin 300 antibacterial agent, about 3 mM EDTA, about 200 parts per million cholic acid, about 0.1% sodium chloride, about 5 mM potassium chloride, about 1 mM calcium acetate, and about 6 mM magnesium acetate at a final pH of 7.0, and said solution maintains the structural integrity of said cells at ambient temperature in vitro while increasing the lysis of whole red blood cells.

In another embodiment of the present invention, a cell preservative solution is provided, wherein the preservative solution comprises about 24% methanol or ethanol, about 0.07% ProClin 300 antibacterial agent, about 3 mM EDTA, about 200 parts per million cholic acid, about 0.1% sodium chloride, about 5 mM potassium chloride, about 1 mM calcium acetate, and about 6 mM magnesium acetate at a final pH of 7.0, and said solution maintains the structural integrity of said cells at ambient temperature in vitro while solubilizing undesired protein material from a sample specimen such as blood or mucus.

In an illustrative practice of the method of the invention, a sample of mammalian cells is provided and, within a specified time frame following biopsy, the cells are suspended in a preservation solution of the invention. In that embodiment of the invention, the sample is placed in the preservation solution to solubilize undesired proteins, such as blood or mucous, from the cell sample. The clean sample may then be transported in the inventive solution for subsequent analysis and/or storage. In accordance with one aspect of the present invention, an aqueous alcohol-buffer solution for maintaining the structural integrity of mammalian cells in vitro, while increasing the solubility of undesirable proteins such as blood or hemoglobin, is provided; said preservative solution comprising about twenty to thirty percent alcohol an anti-clumping agent in an amount sufficient to prevent the cells from clumping in said solution; and a buffering agent which maintains said solution, with the cells, at a pH of about seven. The preserved cells may subsequently be used for immunological, genetic, or cytological analysis or applied to a slide for analysis.

### DETAILED DESCRIPTION OF THE INVENTION

The present invention generally relates to an alcohol-buffer solution and methods for the preservation of mammalian cells in suspension at ambient temperature. The solution enhances maintenance of the nuclear and cytoplasmic structure of the cells, in that it maintains cell membranes intact for subsequent cytological staining and maintains nucleic acid or protein integrity for other molecular or immunological analysis. The solution also effectively destroys microbial pathogens, inhibits retroviral activity, and solubilizes undesired protein material from the sample such as blood or mucus. The invention also provides for methods and kits for preparation of a specimen slide by applying the preserved, suspended mammalian cells to a slide for analysis.

The preservative of the present invention comprises three components with optional fourth, fifth, and sixth components. A first component is a preservative that maintains cellular DNA and protein integrity and retains the detail of the cell and it's nucleus for subsequent cytological staining, analysis, and molecular diagnosis. In one embodiment, the preservative is an alcohol and a preferred alcohol is methanol. Other alcohols that may be used include isopropanol and ethanol among others. In another embodiment of the invention, the alcohol is present in an amount of approximately 20% to 50%, or 20%-40%, or 20% to 30% by volume. In another embodiment of the invention, the alcohol is present in an amount of approximately 21%, or 22%, or 23%, or 24%, or 25%, or 26%, or 27%, or 28%, or 29%. Solutions containing greater than 50% alcohol tend to exhibit cell clumping, and/or protein coagulation, which interferes with the subsequent ability to affectively stain the sample cells. Conversely, if the concentration of alcohol in this embodiment is at 20% or below, the cells are not sufficiently fixed for relatively long-term preservation, causing the cells to degrade over time. In a preferred embodiment, the solution contains approximately 24% methanol, by volume. The preservative of the present invention also removes undesired protein material from a sample specimen such as blood or mucus. The term “increasing the solubility of hemoglobin” as used herein is defined as meaning a reduction in the amount of visible blood in a sample. The reduction in the amount of visible blood in a sample can occur through a number of means including, but not limited to the lysing of red blood cells and the increased solubility of red blood cell proteins, including hemoglobin.

One advantage of the new solution is the ability to solubilize proteins, notably hemoglobin, which may be present in gynecological specimens. Solubility is defined as the amount of solute that can be dissolved in a solvent. The solubility of different proteins (i.e. solutes) varies and is dependent on the solvent used as well as the protein itself. Buffer or solvent type, pH, ionic strength, and temperature all affect protein solubility. Changes in these attributes of a solvent will change the solubility of proteins therein.

Hemoglobin is one of the major protein components of blood cells. The adult form of the protein contains 4 polypeptide chains, 2 of one kind (α) and 2 of another (β), held together by non-covalent interactions. Each chain has an iron-containing heme group which is the binding site for oxygen. The solubility of hemoglobin, as with other proteins, is dependent on the solvent being used. Hemoglobin has an isoelectric point of 6.8, which is the pH at which the molecule is electrically neutral. At a pH above 6.8, hemoglobin has a net negative charge, and below 6.8, a net positive charge. Thus, one preferred embodiment of the present invention is a cell preservative solution that fixes cellular samples while simultaneously allowing the maintenance of the nuclear and cytoplasmic structure of the cells by maintaining cell membranes intact for subsequent cytological staining as well as solubilizing undesired protein material from the sample such as blood or associated blood proteins.

A second component of the preservative is an anti-clumping agent in an amount sufficient to prevent cell clumping. The term “anti-clumping agent” as used herein is defined as meaning an agent that prevents the reaggregation of cells after they have been dispersed into a solution.

In one embodiment, the anti-clumping agent is the chelating agent ethylene diamine tetraacetate (EDTA), with the preferred form being the disodium salt. Other EDTA salts comprising potassium, cesium, rubidium, and various organic cations may also be effective. Other effective anti-clumping agents include, but are not limited to other derivatives of tetraacetic acid such as 1,2-bis(2-aminophenoxy) ethane-N,N,N′,N′-tetraacetic acid (BAPTA), ethylene glycol bis(2-aminoethyl ether)-N,N,N′N′-tetraacetic acid (EGTA) and trans-1,2-diamino cyclohexane-N,N,N′N′-tetraacetic acid (CDTA). Salts of these compounds, which are soluble in the preservative at the preservative concentration, may also effective. Other agents deemed useful as anti-clumping agents include cuminin, heparin, streptokinase, and such agents found in lysing or anticoagulant compositions. Where the preservative is methanol or another alcohol, the anti-clumping agent should be soluble in the methanol or the other alcohol where the preservative is provided in a concentration sufficient to be effective as a preservative.

A third component is a buffer for adjusting the pH of the solution to help retain characteristic morphology of the cells. The buffer used in the inventive solution has a large buffering range to accommodate for the change in pH resulting from autolytic by-products from the sample cells suspended in the solution. For example, as cells age, they release autolytic by-products that alter the pH balance of the suspension solution. In addition, the preservation of different cell types may require solutions of different acidity and within different pH ranges. Accordingly, a solution having a broad buffering range can be used for a wide range of cell types and is optimal for the solution of the invention. Exemplary cells or fluids for which this solution can be used include cervical cells, white blood cells, bronchial cells, urine, ductal lavage, nipple aspirate, and sputum, among other cells and body fluids. The buffer has a pH preferably in the range of about 6 to about 7 but alternatively in the range of about 5 to about 6 or about 7 to about 8. Accordingly, a preferred buffer is an acetate buffer, such as sodium acetate, magnesium acetate, calcium acetate, and combinations thereof. While other buffers, such as N-(2-Acetamido)-2-aminoethanesulfonic acid (ACES), N-(2-Acetamido)iminodiacetic acid (ADA), bis(2-Hydroxyethyl)amino-tris(hydroxymethyl)methane (BIS-TRIS), 2-Morpholinoethanesulfonic acid (MES), and Piperazine-1,4-bis(2-ethanesulfonic acid (PIPES) may be used, the effective buffering range of these buffers is deemed to be not as broad at the desired PH as that of acetate.

An optional fourth component is a substance to maintain the ionic strength within limits that inhibit cell distortion. A specific example is KCl (e.g., at a suggested concentration of about 5 mM of the total preservative), and it must be both soluble in the preservative (e.g., methanol) and not cause precipitation of the anti-clumping agent (e.g., sodium EDTA or derivatives). Alternatively, the substance for maintaining the ionic strength may be an additional amount of the buffer previously added or another compatible buffer.

An optional fifth component is an anti-microbial that kills pathogens. For example, in test samples the preservative effectively kills the following organisms: Candida albicans, Aspergillus niger, Escherichia coli, Pseudomonas aeruginosa, and Staphylococcus aureus. An example is ProClin® 300 (Rohm-Hass, Philadelphia, Pa.) ranging from about 0.01 to about 0.1%. This anti-microbial component is optional depending on the time lapse between collection, shipment and analysis.

An optional sixth component is a mucolytic agent. A mucolytic agent is used to liquefy mucoid cytology specimens to optimize cytological analysis. Excess mucous in a sample can precipitate in alcoholic fixatives and thus may interfere with subsequent slide preparation, staining and analysis. A mucolytic agent dissolves or breaks up clumps of mucous which may contain cells of interest. Examples of mucolytic agents are methyl cysteine, N-acetyl-L-cysteine, dithiothreitol, dihydroxy dithiolbutane, or other agents which are able to break or reduce disulfide bonds.

A detergent may be used in the preservative. The detergent may be non-ionic, cationic, anionic or zwitterionic. Mixtures of detergents may also be used. Exemplary classes of detergents include alcohol ether sulfates, alcohol sulfates, alkanolamides, alkyl sulfonates, amine oxides, amphoteric detergents, anionic detergents, betaine derivatives, cationic detergents, disulfonates, dodecylbenzene sulfonic acid, ethoxylated alcohols, ethoxylated alkyl phenols, ethoxylated fatty acids, glycerol esters hydrotropes, lauryl sulfates, mono and diglycerides, non-ionic detergents, phosphate esters, quaternary detergents, and sorbitan derivatives.

The present invention also provides for methods of preserving cells in a solution. The method comprising the steps of collecting cells from a patient and suspending the cells in a cell preservative solution. The preservative solution may be comprised of about twenty to thirty percent alcohol, an anti-clumping agent in an amount sufficient to prevent the cells from clumping in the solution, and a buffering agent which maintains said solution, with the cells, at a pH of about seven, wherein said solution maintains the structural integrity of cells at ambient temperature in vitro while increasing the solubility of hemoglobin.

Cells of the present invention can be from any source of biological material that can be obtained from a living organism directly or indirectly, including cells, tissue or fluid. Nonlimiting examples of the sample include blood, urine, semen, milk, sputum, mucus, plueral fluid, pelvic fluid, sinovial fluid, ascites fluid, body cavity washes, eye brushing, skin scrapings, a buccal swab, a vaginal swab, a pap smear, a rectal swab, an aspirate, a needle biopsy, a section of tissue obtained for example by surgery or autopsy, plasma, serum, spinal fluid, lymph fluid, the external secretions of the skin, respiratory, intestinal, and genitourinary tracts, tears, saliva, tumors, organs, a microbial culture, a virus, and samples of in vitro cell culture constituents. In particular, the preservative of the present invention can be used with cells collected from the cervix, the breast (including ductal lavage), urinary tract malignancies (both biopsy tissue samples and urine cytology smears), colon, lung, bladder, skin, larynx, esophagus, bronchus, lymph nodes, and haematological malignancies. The preservative may additionally be employed in assessment of pre-malignant abnormalities of cervical squamous epithelial cells (squamous intra-epithelial lesion, SIL) or pre-malignant abnormalities in other tissues. The preservative of the present invention may be particularly appropriate for employment in cytological or biochemical assessment of other clinical specimens where detection of neoplastic cells, or their distinction from cells showing reactive changes, can be very difficult. Such specimens include sputum, bronchio-alveolar lavage specimens, urine and brushings from the alimentary tract (including oesophagus, stomach and pancreas, both bile duct and pancreatic duct). The present invention may be applied in histological or biological assessment of tissue where assessment of proliferation may enable more accurate prediction of clinical outcome, and/or more rational selection of therapy.

Cell samples may be obtained from the patient by a variety of techniques including, for example, by scraping or swabbing an area, or by using a needle or catheter to aspirate body fluids from the chest cavity, bladder, breast duct, spinal canal, or other appropriate area. The cell samples are placed in solution and subsequently collected and transferred to a glass slide for viewing under magnification. Fixative and staining solutions may be applied to the cells on the glass slide for preserving the specimen for archival purposes and for facilitating examination.

It is generally desirable that the cells on the slide have a proper spatial distribution, so that individual cells can be examined. A single layer of cells is typically preferred. Accordingly, preparing a specimen from a fluid sample containing many cells typically requires that the cells first be separated from each other by mechanical dispersion, fluidic shear, or other techniques so that a thin, monolayer of cells can be collected and deposited on the slide. In this manner, the cytotechnologists can more readily discern abnormal cells. The cells are also able to be counted to ensure that an adequate number of cells have been evaluated.

Certain methods and apparatus for generating a thin monolayer of cells on a slide advantageous for visual examination are disclosed in U.S. Pat. No. 5,143,627 issued to Lapidus et al. and entitled “Method and Apparatus for Preparing Cells for Examination;” U.S. Pat. No. 5,240,606 issued to Lapidus et al. and entitled “Apparatus for Preparing Cells for Examination;” U.S. Pat. No. 5,269,918 issued to Lapidus et al. and entitled “Clinical Cartridge Apparatus;” and U.S. Pat. No. 5,282,978 issued to Polk, Jr. et al. and entitled “Specimen Processor Method and Apparatus,” all of which are assigned to the assignee of the present invention and all of the disclosures of which are incorporated herein by reference in their entirety. Samples may be removed from the body using any convenient means and technique. A spatula or swab may be used to remove endothelium cells, e.g. from the cervix or buccal cavity. Blood and other fluid samples may be removed using a syringe or needle. Other tissue samples may be removed by biopsy or tissue section. An automated processor, such as the ThinPrep® 2000 Processor (Cytyc Corporation, Boxborough, Mass.) may be used to collect cells from the liquid and deposit them in a thin layer on a glass slide for analysis. The patient's cells in a preservative fluid in a sample container are dispersed using a spinning sample collector disposed therein. A controlled vacuum is applied to the sample collector to draw the fluid through a screen filter thereof until a desired quantity and spatial distribution of cells is collected against the filter. Thereafter, the sample collector is removed from the sample container and the filter portion impressed against a glass slide to transfer the collected cells to the slide in substantially the same spatial distribution as collected.

Once a specimen is prepared and stained, the specimen may be manually visually inspected by a cytotechnologists, typically under magnification, and with or without various sources of illumination. Alternatively or additionally, automated machine vision systems have been adapted to aid cytological inspection.

The preservative of the present invention may also be used in the preparation of a specimen for selective staining of a macromolecular species (protein, nucleic acid) or a smaller molecule (protein adduct, drug, metabolite, signal transduction species, lipid, etc.). Analysis of preserved tissue is often performed using an antibody that binds specifically and with high affinity to the analyte in the tissue. For sequence-specific detection of nucleic acids, a detectable complementary oligo- or poly-nucleotide sequence (probe) can be used for hybridization. Hybridization can be done on intact cell structures (in situ) for cytometric assay (e.g., by microscopy or flow cytometry). A variety of analytical tests can be performed with better sensitivity and quality control when practiced either directly upon biological samples prepared using the present invention, or upon extracts prepared therefrom. These tests comprise the categories of immunoassays (e.g., IHC, flow immunocytochemistry, ELISA, immunoprecipitation, immunoblotting), assays for nucleic acid quantitation and sequence without amplification (e.g. in situ hybridization, quantitation) or with amplification methods (e.g., PCR, in situ PCR, solution PCR, RT-PCR, ligase chain reaction, strand displacement amplification, NASBA), chromatographic methods (e.g., gas or liquid phase analyte transport), electrophoretic methods (capillary, slab gel) photometric methods (e.g., UV or visible or infra-red spectrophotometry, fluorimetry) and other methods for analysis of molecular compositions (e.g., mass spectroscopy, NMR).

In one embodiment, the preservation time for cells in the present solutions at ambient room temperature (approximately 15-30° C.) is approximately three weeks. This duration may be altered by both the stored age of the solution prior to ambient cell suspension, the amount of time between cell sampling and cell suspension, and the alcohol content. For example, if the solution has been stored for a significant length of time, in either a refrigerated state or an ambient state, then the remaining cell-preserving viability of the solution may be limited.

In practicing the method of the invention, a cell sample or body fluid is obtained from a patient or other cell source. A preservation solution of the type described above is placed either in a vial, on a welled slide, or on an appropriate membrane. The collected cells are then placed in the solution, preferably within one minute following collection. The sooner the collected cells are placed in the preservative solution, the longer the cells can be preserved at ambient temperature suspended in the solution, since the trauma to the cells is minimized.

Following preservation and/or protein removal, when the cells are to be stained or otherwise analyzed, a device can be used to remove suspended cells, along with the suspension preservation medium, and place them on a slide or other appropriate surface for further processing. The invention is described further in the following non-limiting examples.

### EXAMPLE

One embodiment of the present invention includes the following formulation:
about 24% methanol or ethanol by volume;
about 0.07% ProClin 300 antibacterial agent;
about 3 mM EDTA,
about 200 parts per million cholic acid,
about 0.1% sodium chloride,
about 5 mM potassium chloride,
about 1 mM calcium acetate, and

about 6 mM magnesium acetate at a final pH of 7.0.

In this formulation, the function of the calcium and magnesium ions is the preservation of nuclear morphology of cytologically significant cells. The acetate is present as a buffer that will both stabilize the pH of the solution, and not form precipitates of calcium and magnesium. Such precipitation would happen with a phosphate buffer. The sodium and potassium salts are present to help stabilize the cells and prevent precipitation and coagulation of hemoglobin and other serum proteins. The methanol is present to aid in the lysing of red blood cells, to act as a preservative against bacterial growth, and to help preserve cytologically significant cells.

The invention can be embodied in other specific forms without departing from the spirit or essential characteristics thereof. The present embodiments are therefore to be considered in all respects as illustrative and not restrictive. The scope of the invention is indicated by the appended claims, rather than by the foregoing description, and all changes which come within the meaning and range of equivalency of the claims are therefore intended to be embraced therein.

1. A method of preserving cells in a solution, said method comprising the steps of;
collecting cells from a patient; and
suspending said cells in a cell preservative solution, said solution comprising;
about twenty to thirty percent alcohol;
an anti-clumping agent in an amount sufficient to prevent the cells from clumping in said solution; and
a buffering agent which maintains said solution, with the cells, at a pH of about seven;
wherein said solution maintains the structural integrity of cells at ambient temperature in vitro while increasing the solubility of hemoglobin.

2. The solution of claim 1 wherein said alcohol is selected from the group consisting of ethanol, isopropanol, and methanol.

3. The solution of claim 1 wherein said alcohol is methanol.

4. The solution of claim 1 wherein said anti-clumping agent is a chelating agent selected from the group consisting of ethylenediamine tetraacetic acid and salts thereof.

5. The solution of claim 1 wherein said anti-clumping agent is ethylenediamine tetraacetic acid.

6. The solution of claim 1 wherein said alcohol constitutes about 24 percent of said solution.

7. The solution of claim 1 wherein said buffering agent is selected from the group consisting of phosphate buffered saline, Tris buffer, sodium acetate, ethylenediamine tetraacetic acid, ethylenediamine tetraacetic acid salts, citric aid and citric acid salts.

8. The solution of claim 1, wherein said aqueous solution contains an antibacterial agent.

9. The solution of claim 1 wherein said buffering agent is selected from the group consisting of magnesium acetate, calcium acetate, potassium chloride, and sodium chloride.

10. The solution of claim 1 further comprising a mucolytic agent.

11. A method of preserving cells in a solution, said method comprising the steps of;
collecting cells from a patient; and
suspending said cells in a cell preservative solution, said solution comprising;
about 24% methanol or ethanol by volume;
about 0.07% ProClin 300 antibacterial agent;
about 3 mM EDTA,
about 200 parts per million cholic acid,
about 0.1% sodium chloride,
about 5 mM potassium chloride,
about 1 mM calcium acetate, and
about 6 mM magnesium acetate at a final pH of 7.0.
wherein said solution maintains the structural integrity of cells at ambient temperature in vitro while increasing the solubility of hemoglobin.

12. A method of preserving cells to render them useful for subsequent immunological, genetic, or cytological analysis, wherein the method comprises the steps of:
collecting cells from a patient;
suspending said cells in a cell preservative solution, said solution comprising; about twenty to thirty percent alcohol; an anti-clumping agent in an amount sufficient to prevent the cells from clumping in said solution; and a buffering agent which maintains said solution, with the cells, at a pH of about seven; and
removing a portion of said preserved cells for immunological, genetic, or cytological analysis.

13. The solution of claim 12 wherein said alcohol is selected from the group consisting of ethanol, isopropanol, and methanol.

14. The solution of claim 12 wherein said alcohol is methanol.

15. The solution of claim 12 wherein said anti-clumping agent is a chelating agent selected from the group consisting of ethylenediamine tetraacetic acid and salts thereof.

16. The solution of claim 12 wherein said anti-clumping agent is ethylenediamine tetraacetic acid.

17. The solution of claim 12 wherein said alcohol constitutes about 24 percent of said solution.

18. The solution of claim 12 wherein said buffering agent is selected from the group consisting of phosphate buffered saline, Tris buffer, sodium acetate, ethylenediamine tetraacetic acid, ethylenediamine tetraacetic acid salts, citric aid and citric acid salts.

19. The solution of claim 12, wherein said aqueous solution contains an antibacterial agent

20. The solution of claim 12 wherein said buffering agent is selected from the group consisting of magnesium acetate, calcium acetate, potassium chloride, and sodium chloride.

21. The solution of claim 12 further comprising a mucolytic agent.
